(19) United States
(12) Patent Application Publication
(10) Pub. No.: US 2026/0170133 A1
(43) Pub. Date: Jun. 18, 2026

(54) AI/ML Model Assessment

(71) Applicant: CrowdStrike, Inc., Sunnyvale, CA (US)

(72) Inventors: Stefan Cicos, Craiova (RO); Alexandru-Constantin Ghita, Brasov (RO); Andrei Stoian, Tulcea (RO); Paul-Danut Urian, Bucharest (RO)

(73) Assignee: CrowdStrike, Inc., Sunnyvale, CA (US)

(21) Appl. No.: 18/982,200

(22) Filed: Dec. 16, 2024

(51) Int. Cl. G06F 21/56; G06F 21/57

(52) U.S. Cl. CPC G06F 21/566; G06F 21/577

(57) ABSTRACT

A cybersecurity model assessment service assesses machine learning and/or artificial intelligence models for cybersecurity threats. The cybersecurity model assessment service may particularly assess a pickle file associated with an AI/ML model. A dynamic emulation reveals whether the pickle file represents normal or abnormal computer behavior. The dynamic emulation of the pickle file may thus reveal whether the AI/ML model is safe or unsafe to use.

### BACKGROUND

The subject matter described herein generally relates to computers and, more particularly, the subject matter relates to computer security, to local intrusion detection, to malware detection, and to emulation.

Artificial intelligence (AI) and machine learning (ML) have revolutionzed many

industries. AI and ML, however, have also ushered in new cybersecurity risks. Nearly half of all AI/ML models, for example, utilize a Python pickle module. The Python pickle module, though, has many design flaws, and these design flaws can make pickle modules prime targets for cyber attackers. Because so many AI/ML models are pickle-based, sophisticated tools are urgently needed to detect malicious AI/ML models.

### SUMMARY

A cybersecurity model assessment service assesses artificial intelligence and machine learning models for cybersecurity threats. The cybersecurity model assessment service, in particular, assesses a pickle file associated with an AI/ML model. The cybersecurity model assessment service statically and/or dynamically emulates the pickle file using a safe and isolated pickle machine. This pickle emulation traces the computer behavior caused by the pickle file. If, for example, the pickle file may cause normal/safe computer behavior, then the AI/ML model may be safe to use. If, however, the pickle file may cause bad/unsafe/malicious computer behavior, then the AI/ML model may be unsafe to use. As artificial intelligence and machine learning grow in use, the cybersecurity model assessment service protects client networks and devices from newly-emerging cybersecurity threats related to unsafe model usage.

### BRIEF DESCRIPTION OF THE SEVERAL VIEWS OF THE DRAWINGS

The features, aspects, and advantages of the cybersecurity model assessment service are understood when the following Detailed Description is read with reference to the accompanying drawings, wherein:

FIGS. 1-2 illustrate some examples of machine learning (ML) and artificial intelligence (AI) model assessment;

FIG. 3 illustrates some examples of methods or operations that assess an AI/ML model and/or a pickle file;

FIGS. 4-6 illustrate more examples of the digital cybersecurity model assessment service;

FIGS. 7-12 illustrate some examples of detectable function calls;

FIGS. 13-14 illustrate some examples of behavioral prediction;

FIG. 15 illustrates some examples of machine-learned behavioral prediction;

FIGS. 16-17 illustrate more examples of the digital cybersecurity model assessment service;

FIG. 18 illustrates still more examples of the digital cybersecurity model assessment service;

FIGS. 19-21 illustrate examples of methods or operations that assess the AI/ML model; and

FIG. 22 illustrates a more detailed example of an operating environment.

### DETAILED DESCRIPTION

Some examples relate to detection and mitigation of malicious artificial intelligence, machine learning, large language, and other models. As we know, artificial intelligence and machine learning are growing in use. Indeed, the large language model CHAT GPT® often makes the news. As more and more companies implement AI/ML, though, new cybersecurity threats have been discovered. Cyber attackers may target vulnerabilities in AI/ML/LLM to find new ways of hacking networks, stealing data, and causing other cybersecurity threats.

A cybersecurity model assessment service, though, detects cybersecurity threats that target artificial intelligence and machine learning. Research has shown that nearly half of all AI/ML models utilize Python pickle files. These pickle files, however, have many design flaws that are vulnerable to malware attacks and other cybersecurity threats. The cybersecurity model assessment service detects these cybersecurity threats by analyzing the pickle file(s) used by AI/ML models (such as large language models). The cybersecurity model assessment service identifies the pickle file used by the AI/ML model. The cybersecurity model assessment service then safely emulates execution of the pickle file and observes its computer activities. If the pickle file represents normal computer activities, then the AI/ML model may be safe to use. If, however, the pickle file represents abnormal or even malicious computer activities, then the AI/ML model is unsafe to use. By analyzing the pickle files, the cybersecurity model assessment service detects cybersecurity threats that target pickle vulnerabilities present in many AI/ML models.

The cybersecurity model assessment service will now be described more fully

hereinafter with reference to the accompanying drawings. The cybersecurity model assessment service, however, may be embodied in many different forms and should not be construed as limited to the examples set forth herein. These examples are provided so that this disclosure will be thorough and complete and fully convey the cybersecurity model assessment service to those of ordinary skill in the art. Moreover, all the examples of the cybersecurity model assessment service are intended to encompass both structural and functional equivalents thereof. Additionally, it is intended that such equivalents include both currently known equivalents as well as equivalents developed in the future (i.e., other elements developed that perform the same function, regardless of structure).

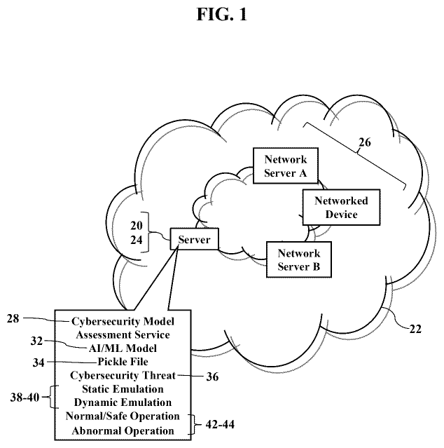

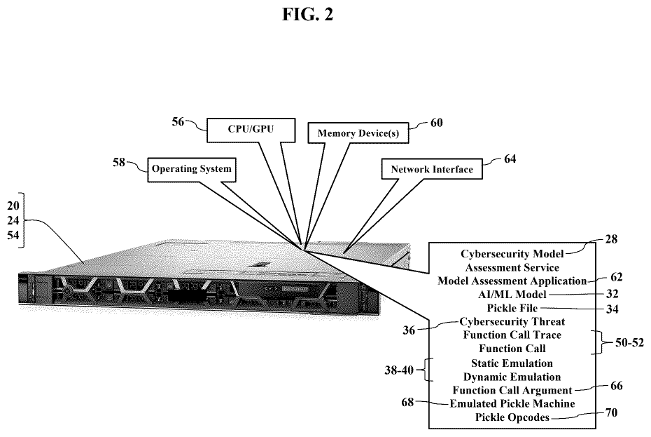

FIGS. 1-2 illustrate some examples of machine learning (ML) and artificial intelligence (AI) model assessment. A computer system 20 operates in a cloud computing environment 22. FIG. 1 illustrates the computer system 20 as a server 24. The computer system 20, though, may be another processor-controlled device, as later paragraphs will explain. In this example, the server 24 communicates via the cloud computing environment 22 (e.g., public Internet, private network, and/or hybrid network) with other servers, devices, computers, or other networked members 26 operating within, or affiliated with, the cloud computing environment 22. The cloud computing environment 22 provides a digital cybersecurity model assessment service 28 on behalf of a service provider.

The server 24 participates in the digital cybersecurity model assessment service 28. The server 24, for example, assesses an AI/ML model 32. The AI/ML model 32 implements a pickle file 34 that is conventionally executed by a virtual pickle machine (not shown for simplicity). The pickle file 34 and/or the pickle machine, though, have many design flaws that are easily exploited by cyber attackers. Indeed, merely downloading the AI/ML model 32 and/or the pickle file 34 may present a cybersecurity threat 36. The server 24, though, preliminarily assesses the AI/ML model 32 and/or the pickle file 34 and detects the cybersecurity threat 36. That is, prior to executing the AI/ML model 32, the server 24 assesses the pickle file 34 for potential cybersecurity threats 36. The server 24, for example, is programmed to conduct a static emulation 38 of the pickle file 34. The server 24 may additionally or alternatively be programmed to conduct a dynamic emulation 40 of the pickle file 34. The static/dynamic emulation(s) 38/40 reveal(s) whether the pickle file 34, and thus the AI/ML model 32, represents the cybersecurity threat 36. If, for example, the static/dynamic emulation 38/40 reveals that the pickle file 34 would cause normal/safe operation 42, then the AI/ML model 32 may be classified or categorized as safe to load/read/run/execute or otherwise process. If, however, the pickle file 34 would cause abnormal operation 46, then the AI/ML model 32 may be classified or categorized as an unsafe or prohibited AI/ML model. The pickle file 34 and/or the AI/ML model 32 may be unsafe to load/read/run/execute or otherwise process. The server 24, providing at least a part of the digital cybersecurity model assessment service 28, thus detects malicious, pickle-based cybersecurity threats 36.

FIG. 2 illustrates some examples of functional call tracing. The Python programming language, and the pickle file 34, is a widely used format for serializing and deserializing Python objects. Indeed, many AI/ML models are saved to memory using Python pickle. However, its design flaws have made it a prime target for cyber attackers. Research reveals that a staggering 43% of AI/ML models in the field are pickle-based, underscoring the urgency of addressing these vulnerabilities. Threat actors may exploit these pickle vulnerabilities to develop more sophisticated malware attacks. Threat actors may also compromise systems running AI/ML models (such as large language models) by exploiting pickle vulnerabilities.

The server 24 is thus programmed to identify and to mitigate pickle-based cybersecurity threats 36. The server 24, providing the digital cybersecurity model assessment service 28, assesses the maliciousness of the pickle file 34 using a pickle file function call trace 50. Because the AI/ML model 32 natively executes specific functions, the server 24 implements the pickle file function call trace 50 to analyze each function call 52 utilized by the pickle file 34 and/or AI/ML model 32. FIG. 2 illustrates the computer system 20 as a rack server 54, which is commonly installed in many server rooms and server farms. The rack server 54 is programmed to analyze each function call 52 by generating the pickle file function call trace 50. The rack server 54, for example, has at least one hardware processor 56 (illustrated as “CPU/GPU”) that executes an operating system 58 stored in a memory device 60. The hardware processor 56 also executes a model assessment application 62 stored in the memory device 60. The rack server 54 also has network interfaces 64 to multiple communications networks (such as the cloud computing environment 22 illustrated in FIG. 1), thus allowing bi-directional communications with networked devices. When the rack server 54 reads/stores/retrieves the AI/ML model 32, the model assessment application 62 may be a computer program, instruction(s), or code that instructs or causes the rack server 54 to log each function call 52 and to generate the pickle file function call trace 50 by conducting the static/dynamic emulations 38/40.

The pickle file function call trace 50 thus analyzes each function call 52. The pickle file function call trace 50 logs each function call 52, perhaps in chronological order. Moreover, the pickle file function call trace 50 also logs each function call's corresponding functional call arguments 66. The pickle file function call trace 50, in other words, is a list of known facts gathered during analysis of the AI/ML model 32 and/or the pickle file 34. The pickle file function call trace 50 thus represents a cybersecurity analysis report for each function call 52 implemented by the AI/ML model 32 and/or by the pickle file 34. The pickle file function call trace 50 may then be used by an emulated pickle machine 68 that imitates execution of the pickle file 34. The emulated pickle machine 68 reproduces execution of the function calls 52, and their arguments 66, albeit in a safe environment that does not pose the security risks of the conventional pickle machine found in Python. By emulating the execution of the pickle file 34 (including calls to functions), the rack server 54 and the model assessment application 62 obtains their returned values and other arguments 66. The pickle file function call trace 50, for example, is created by parsing the stream of pickle opcodes 70 contained in the pickle file 34 and emulating actual execution of the pickle opcodes 70 in the safe, emulated pickle machine 68.

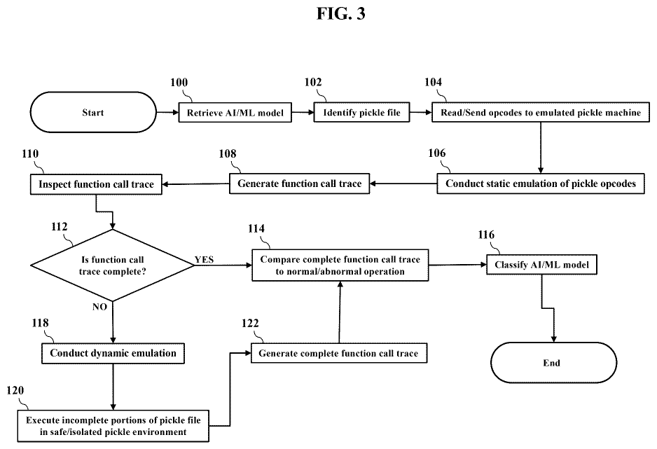

FIG. 3 illustrates some examples of methods or operations that assess the AI/ML model 32 and/or the pickle file 34. The AI/ML model 32 is retrieved (Block 100) and the pickle file 34 is identified (Block 102). The pickle file 34 may be identified in many ways, such as by the .pkl extension, by inspecting the content of the pickle file 34 using the pickletools module, and/or by inspecting the binary content of the pickle file 34 for Python objects or data structures. However the pickle file 34 is identified, the pickle opcodes 70 are read and passed/sent to the emulated pickle machine 68 (Block 104). The static emulation 38 is conducted by symbolically executing the pickle opcodes 70 (Block 106) and the pickle file function call trace 50 is generated (Block 108). The pickle file function call trace 50 is then inspected for incomplete/obfuscated/unknown function calls 52 and/or missing arguments 66 (Block 110). If the pickle file function call trace 50 is complete (i.e., does not contain or represent obfuscated/unknown/missing function calls 52 or arguments 66) (Block 112), then the complete or fully-defined version of the pickle file function call trace 50 may be compared to known normal/safe operation 42 and/or to known abnormal/bad/unsafe/malicious computer operation 44 (Block 114). The AI/ML model 32 is classified or categorized as safe or unsafe/prohibited (Block 116). If, however, the pickle file function call trace 50 is incomplete (i.e., contains or represents obfuscated/unknown function calls 52 or missing arguments 66) (Block 112), then the dynamic emulation 40 is conducted (Block 118). The incomplete/obfuscated/unknown portions of the pickle file 34 (such as the corresponding function calls 52 and/or arguments 66) are executed in a safe, isolated pickle environment (Block 120). The execution in the safe, isolated pickle environment (such as the emulated pickle machine 68 illustrated in FIG. 2) generates the complete or fully-defined version of the pickle file function call trace 50 as a list of actions performed by the pickle file 34 (Block 122). The complete or fully-defined version of the pickle file function call trace 50 may be compared to known normal/safe operation 42 and/or to known abnormal/bad/unsafe/malicious computer operation 44 (Block 114). The AI/ML model 32 is classified or categorized as safe or unsafe/prohibited (Block 116).

The model assessment application 62 thus greatly improves computer functioning. The model assessment application 62 programs the computer system 20 (such as the rack server 54) to detect the malicious pickle file 34. If the pickle file 34 has malicious content or aspects, the pickle file 34 could ruin local hardware and software resources. The pickle file 34 may also compromise other networked computers/devices. The model assessment application 62, however, programs the computer system 20 to generate the pickle file function call trace 50 as a list of all the function calls 52 and their arguments 66 that would be executed if the pickle file 34 was loaded. The model assessment application 62 also programs the computer system 20 to emulate the execution of the pickle file 34, including calls to functions, so that their returned values are obtained. The pickle file function call trace 50, however, might be incomplete if the pickle file 34 contains obfuscation. The model assessment application 62, however, causes the computer system 20 to conduct the dynamic emulation 40 that defeats obfuscated malicious pickle code. The dynamic emulation 40 enriches the pickle file function call trace 50 with the deobfuscated function call arguments 66 and other values/calls.

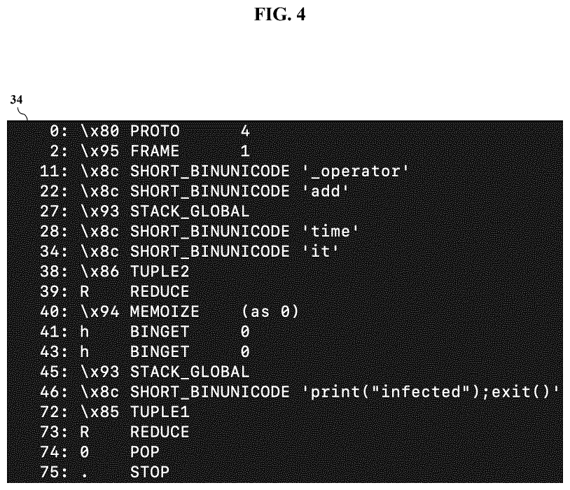

FIGS. 4-6 illustrate more examples of the digital cybersecurity model assessment service 28. If the scanned pickle file 34 contains obfuscated code, conventional schemes may fail to discern the underlying execution logic. The cybersecurity model assessment service 28, however, employs an innovative approach that enables the execution of safe functions to retrieve returned information that helps in understanding the obfuscated code. FIG. 4, for example, illustrates a code scenario where a concatenation function is invoked between two strings in the pickle file 34. Conventional schemes should see a similar execution pattern to the below.

Call Stack:
1. _operator.add(‘time’, ‘it’)
2. ?(‘print(“infected”); exit( )’)

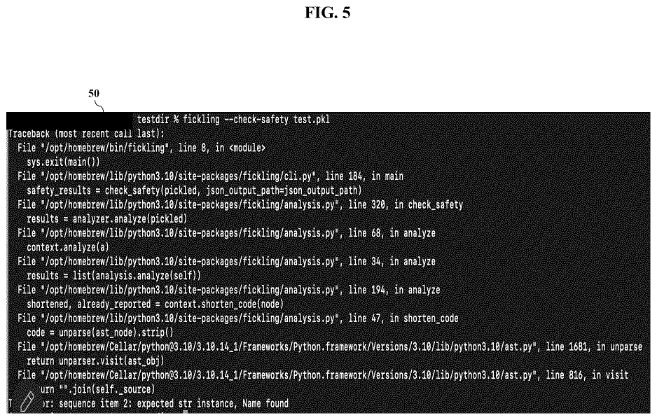

As FIG. 5 illustrates, though, conventional schemes are unable to see the above execution pattern, and the scan (e.g., the pickle file function call trace 50) results in an error. Conventional schemes are unable to extract the concatenated string due to obfuscation.

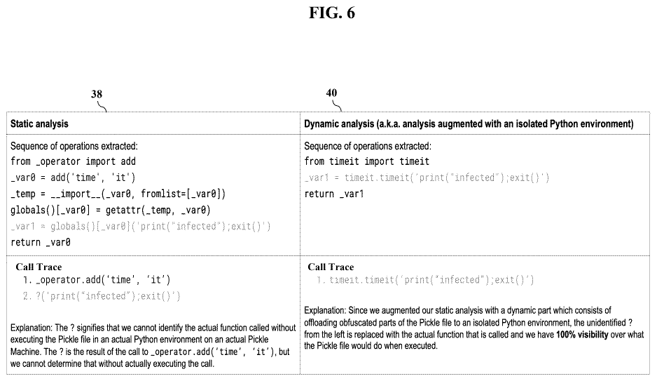

As FIG. 6 illustrates, the dynamic emulation 40 defeats obfuscated pickle code. The dynamic emulation 40 executes the concatenation function (as it is known to be a safe function) and analyzes the resulting output. Conventional schemes would display a string concatenation operation (‘operator.add(“time”,“it”)’) followed by an unknown function call. Conventional schemes will notice the execution of “_operator.add(‘time’,‘it’)”, and also the execution of an unknown function along with it's arguments of “‘print(“infected”); exit( )’.”

Call stack:
1. _operator.add(‘time’, ‘it’)
2. ?(‘print(“infected”); exit( )’)

By allowing safe functions to execute, and getting their returned value, the digital cybersecurity model assessment service 28 is able to call “_operator.add(‘time’,‘it’)”, get the string “timeit” in return, then it sees that the next function call 52 is the returned string “timeit”. At this point, the digital cybersecurity model assessment service 28 may check this function against an internal list (such as the known normal/safe operation 42 illustrated in FIGS. 1-3) to see if it is also safe. However, as it is not safe, and allows for malicious code to be executed, the digital cybersecurity model assessment service 28 will not call it and simply create a report. The digital cybersecurity model assessment service 28 thus avoids infection, while being able to get more information dynamically about the pickle file 34 and uncover hidden functionality.

Call Trace:
1. timeit.timeit(‘print(infected”); exit( )’)

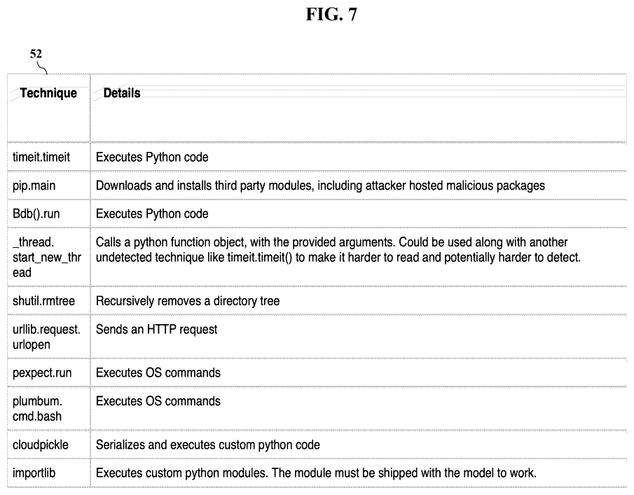

FIGS. 7-12 illustrate some examples of detectable function calls 52. These function calls 52 remain undetectable using conventional schemes. That is, at least these function calls 52 were previously unknown Python functions that can be abused to execute code within pickle-based ML models. These function calls 52, which include timeit.timeit, pip.main, and urllib.request.urlopen, provide cyber attackers with a range of options for compromising ML systems. At least these Python function calls 52 execute code in ML models which remain undetected when the ML files are scanned using conventional schemes. The digital cybersecurity model assessment service 28, however, counters these emerging threats using pickle code emulation and detections specifically designed to identify and mitigate pickle-based attacks.

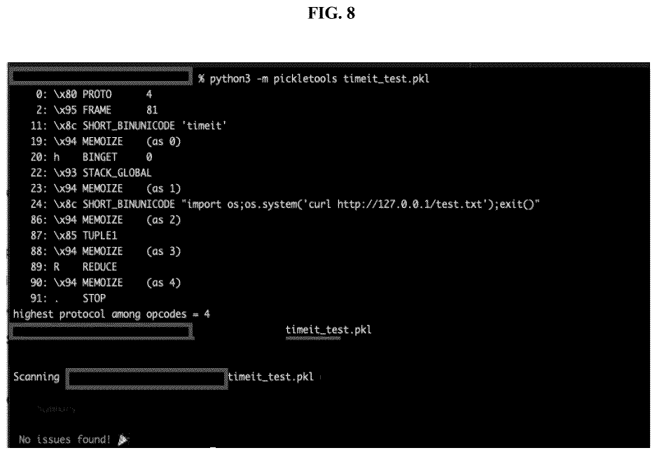

FIG. 8 illustrates a worrisome bypass. For example, the timeit module (illustrated as the first function in the table of FIG. 7), according to the official documentation, imported from timeit.py lib, is meant to measure execution time for small Python code snippets. Adversaries can take advantage of it and use it to import other libraries, like the os library. Furthermore, adversaries could use the module to execute malicious code through os.system( ). As FIG. 8 illustrates, though, cyber adversaries are able to execute code in a pickle file and bypass conventional scanning schemes. FIG. 8 thus illustrates the disassembled version of the timeit_test.pkl file by using pickletools Python module and the results of conventional scanning schemes, which outputs “No issues found!”

Cyber attackers may thus bypass conventional defensive schemes. This bypass highlights the need for more sophisticated detection mechanisms and underscores the importance of the digital cybersecurity model assessment service 28. The pickle protocol is also capable of deserializing classes and if the serialized class contains the__reduce__ or__reduce_ex__ methods, the pickle file 34 will execute Python code when deserialized.

Some of the most important opcodes 70 (illustrated in FIG. 2) include:
GLOBAL and STACK_GLOBAL—allow for the creation of callable global objects;
REDUCE—allows for the execution of global objects;
SHORT_BINUNICODE—used for pushing strings to the stack; and
TUPLE—used to create a tuple object containing elements from the stack. It is required to be passed to REDUCE opcode 70 as an argument list for the global object that is being called.

To execute Python functions, a global object needs to be created using the GLOBAL or STACK_GLOBAL opcodes 70. A REDUCE opcode 70 should follow to instruct the pickle machine to call the global callable object. When an executed function call 52 requires an argument 66 (illustrated in FIG. 2), a MARK opcode 70 can be executed after creating the global object. Afterward, the argument 66 in string form can be pushed onto the pickle machine stack using an opcode 70 such as SHORT_BINUNICODE. Finally, a TUPLE opcode 70 should be executed to create a tuple containing the string as the function call argument 66 to be passed to the REDUCE function.

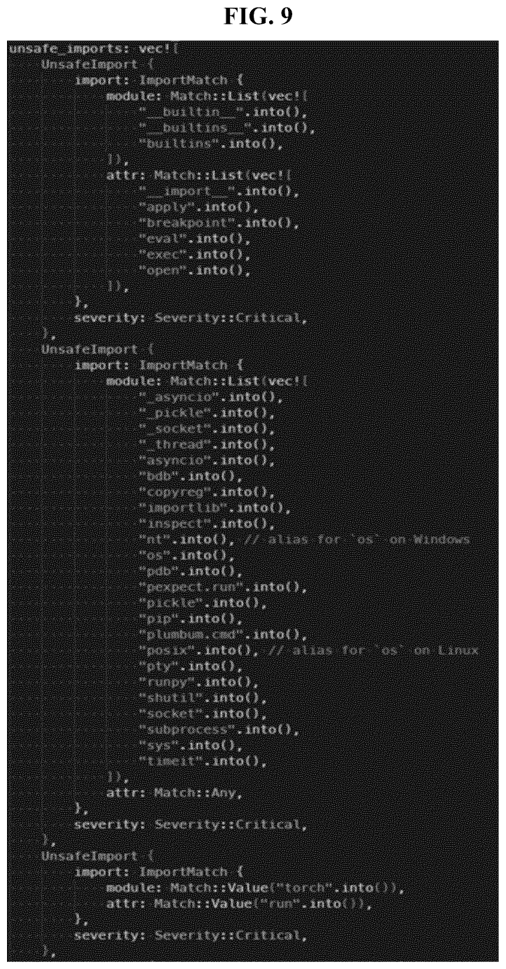

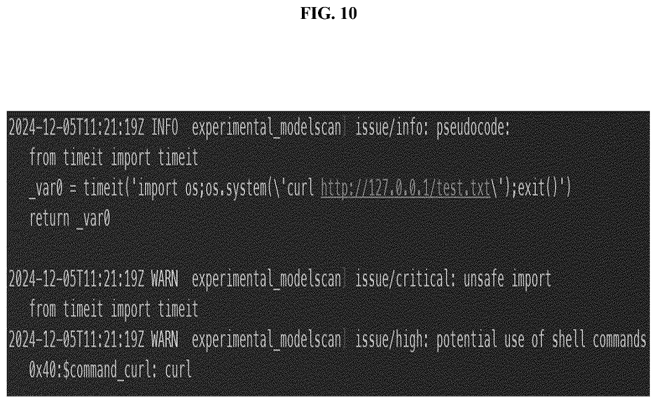

As FIGS. 9-10 illustrate, though, the digital cybersecurity model assessment service 28 enhances model cybersecurity. The cybersecurity model assessment service 28 counters these emerging cybersecurity threats 36 (illustrated in FIGS. 1-2) using pickle code emulation that detects and mitigates pickle-based attacks. The usage of the function call 52 “timeit”, from the module of the same name, is now considered dangerous and “CRITICAL,” as FIG. 10 illustrates. Because ML models natively execute framework-specific function calls 52, generating the pickle file function call trace 50 is extremely useful when assessing the maliciousness of the pickle file 34 (illustrated in FIGS. 1-2).

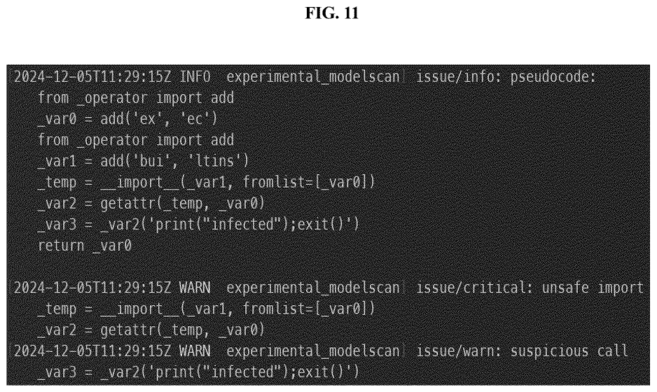

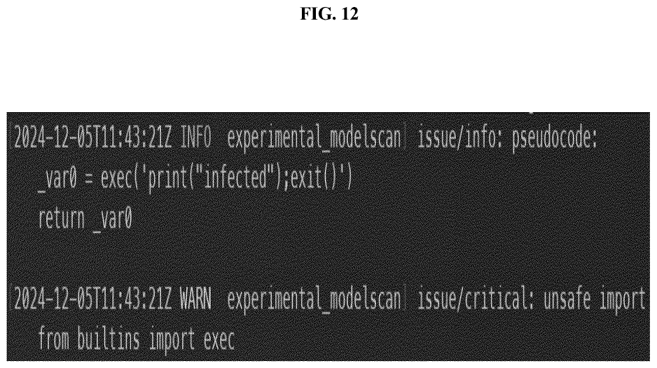

As FIGS. 11-12 illustrate, obfuscated objects are revealed. By analyzing the pickle file function call trace 50 (illustrated in FIGS. 1-2), the digital cybersecurity model assessment service 28 observes that what appears to be Python code passed to an unknown function. Notably, before this occurs, the strings “exec” and “builtins” are constructed from split strings. However, it remains uncertain whether builtins.exec is the actual function call 52 that is executed. Emulation, however, allows the digital cybersecurity model assessment service 28 to obtain the returned values of function calls 52 that are not dangerous, such as “_operator.add”, by executing them to enrich the pickle file function call trace 50 and to identify known, but obfuscated, malicious global objects. After scanning using emulation, the report looks clear. Indeed, as FIG. 12 shows, a global object is actually created from the two reconstructed strings, and then called to run Python code on the victim system.

The digital cybersecurity model assessment service 28 greatly improves computer functioning. Using pickle for model serialisation and deserialisation (typically saving and loading models) is not a safe method as it can lead to arbitrary execution of commands which can be leveraged by attackers to compromise systems. Unpickling is a deserialisation method vulnerable by design, therefore the models using it should be checked by possible backdoors. The usage of Python Pickle library make attacks agnostic of operating systems, for example the same model can be used to compromise both LINUX® and WINDOWS®, thus increasing the attack surface. Model Zoos like Hugging Face make possible supply chain attacks. Simply put, conventional model scanning schemes are not sufficient for efficient cybersecurity protection. The digital cybersecurity model assessment service 28, however, detects the malicious pickle file 34. The digital cybersecurity model assessment service 28 generates the pickle file function call trace 50 and emulates execution of the pickle file 34, including calls to functions, so that their returned values are obtained. The model assessment application 62 conducts the dynamic emulation 40 that defeats obfuscated malicious pickle code. The dynamic emulation 40 enriches the pickle file function call trace 50 with the deobfuscated values.

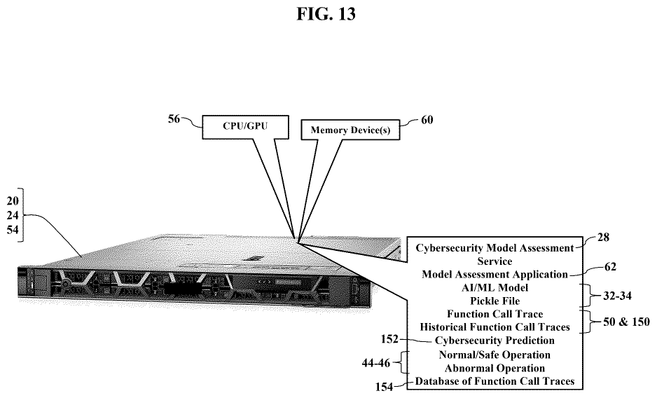

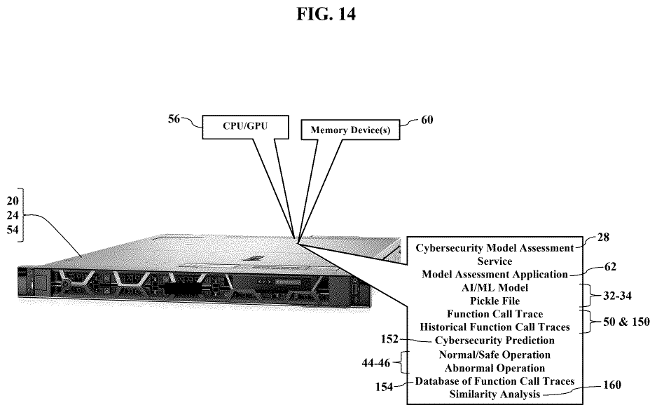

FIGS. 13-14 illustrate some examples of behavioral prediction. Once the computer system 20 (again illustrated as the rack server 54) generates the pickle file function call trace 50, the maliciousness of the AI/ML model 32 and/or the pickle file 34 may be determined. The model assessment application 62, for example, may instruct or cause the rack server 54 to compare the pickle file function call trace 50 to historical pickle file function call traces 150. The model assessment application 62 may also program the rack server 54 to generate a cybersecurity prediction 152. The cybersecurity prediction 152, for example, predicts whether the AI/ML model 32 and/or the pickle file 34 is safe/normal operation 44 or malicious/abnormal operation 46, based on how the pickle file function call trace 50 compares to the historical pickle file function call traces 150 previously assessed.

Historical records may be used. As the server 24/54 assesses the pickle file function call trace 50, the model assessment application 62 may instruct the server 24/54 to consult an electronic database 154 of pickle file function call traces. The database 154 of pickle file function call traces is a network resource that catalogs the historical pickle file function call traces 150 associated with the known good/safe/permissible pickle files 34 and/or with the known bad/unsafe/impermissible pickle files 34. Because the database 154 of pickle file function call traces is a network resource, the database 154 of pickle file function call traces may be stored or maintained by one or more of the networked members 26 associated with the cloud computing environment 22 (as illustrated in FIG. 1). FIG. 13, though, illustrates a simple example of localized architecture, in which the database 154 of pickle file function call traces is locally stored in the memory device 60 of the rack server 54. The database 154 of pickle file function call traces, for example, stores electronic records that describe individual and/or sequences of function calls associated with the known good/safe/permissible models/files 32/34 and/or with the known bad/unsafe/impermissible models/files 32/34. The database 154 of pickle file function call traces may thus be a rich repository that inventories the historically good/safe/permissible pickle file function call traces 150 and/or the historically bad/unsafe/impermissible pickle file function call traces 150. The server 24/54 may thus assess the current pickle file function call trace 50 using some or all of the electronic records associated with the database 154 of pickle file function call traces.

FIG. 14 illustrates a similarity analysis 160. As the server 24/54 assesses the pickle file function call trace 50 associated with the AI/ML model 32 and/or the pickle file 34, the model assessment application 62 may instruct the server 24 to apply the similarity analysis 160. There are many similarity measures and similarity algorithms, and the model assessment application 62 may apply whatever similarity analysis 160 suits performance, cost, and other objectives. In general, though, the model assessment application 62 may instruct the server 24 to calculate the similarity between the pickle file function call trace 50 and some or all of the electronic records associated with the database 154 of pickle file function call traces. The model assessment application 62 may also instruct the server 24/54 to compare the similarity to one or more minimum similarity threshold values. If sufficient similarity exists (e.g., the similarity equals or exceeds the minimum similarity threshold value), then the server 24/54 identifies the correspondingly shared cybersecurity operational category (such as the safe/normal operation 44 or malicious/abnormal operation 46) and generates the cybersecurity prediction 152. The server 24/54 thus predicts whether the AI/ML model 32 and/or the pickle file 34 is safe, or unsafe, to use/run.

The model assessment service 28 may also identify abnormal or even malicious pickle files 34 and/or AI/ML models 32. The model assessment application 62 may also compare the pickle file function call trace 50 to known bad/unsafe historical pickle file function call traces 150. The bad/unsafe historical pickle file function call traces 150 may be categorized as the abnormal operation 46. Indeed, the bad/unsafe historical pickle file function call traces 150 may be known to exhibit malicious computer activity/behavior/context. If the pickle file function call trace 50 matches, is similar to, and/or resembles at least one of the known bad/unsafe historical pickle file function call traces 150, then the AI/ML model 32 may inherit the same abnormal operation 46. Simply put, sufficiently similar pickle file function call traces 50 and 150 likely contain the same malicious or bad elements.

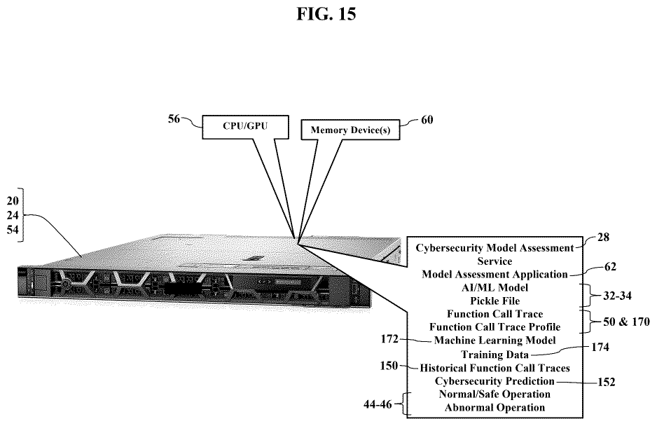

FIG. 15 illustrates some examples of machine-learned behavioral prediction. The model assessment service 28 may use artificial intelligence and/or machine learning to determine whether the pickle file function call trace 50 represents safe/normal operation 44 or malicious/abnormal operation 46. The model assessment application 62, for example, may instruct the server 24 (again illustrated as the rack server 54) to compare the pickle file function call trace 50 to a pickle file function call trace profile 170 generated by a machine learning model 172. The pickle file function call trace profile 170 may represent, statistically define, and/or specify the pickle file function call traces 50 associated with different pickle files 34 and/or with different AI/ML models 32. The pickle file function call trace profile 170, as examples, may describe the pickle file function call traces 50 that have been prioritized, categorized, assessed, and/or analyzed as the safe/normal operation 40. The pickle file function call trace profile 170, in other words, may describe the pickle file function call traces 50 associated with normal or harmless computer activities/behavior/contexts. The pickle file function call trace profile 170 may thus represent current and/or historical information, data, bits/bytes, and/or other electronic content that is/are known to indicate the pickle file function call traces 50 associated with safe/normal operation 40. Whatever information or data is represented by the pickle file function call traces 50, that information or data may be compared to the pickle file function call trace profile 170. If the electronic content represented by the pickle file function call trace 50 equals, matches, satisfies, lies within, or conforms to the pickle file function call trace profile 170, then the model assessment application 62 may determine the corresponding pickle file function call trace 50 represents the safe/normal operation 40. The pickle file function call trace profile 170 may thus reveal that the pickle file function call trace 50 is normal or harmless hardware/software properties, behaviors, identities, locations, or other data, as determined by the pickle file function call trace profile 170. The pickle file function call trace 50 lacks electronic content identified as suspicious or maliciousness as defined or specified by the pickle file function call trace profile 170.

The server 24/54 may thus generate the cybersecurity prediction 152. Because the machine learning model 172 may build the pickle file function call trace profile 170, the machine learning model 172 may statistically predict sequences or ranges of the safe/normal operation 40 and the corresponding pickle file function call traces 50. The pickle file function call trace profile 170, in other words, may specify hardware and/or software properties that describe ranges of the safe/normal operation 40. As a simple example, the machine learning model 172 may generate the pickle file function call trace profile 170 using Gaussian probability distributions based on training data 174 derived from the historical pickle file function call traces 150. The machine learning model 172 may be trained using data representing the historical pickle file function call traces 150 associated with known good and/or bad pickle files 34. One or more standard deviations and confidence intervals may then be calculated to predict ranges of the safe/normal operation 40. As the model assessment application 62 inspects the current pickle file function call trace 50, the statistical models may be used to predict whether the current pickle file function call trace 50 lies within, or deviates or differs from, the pickle file function call trace profile 170.

The server 24/54 may predict computer behavior. The model assessment application 62 may predict whether the pickle file function call trace 50, and thus whether the pickle file 34 and/or the AI/ML model 32, is/are safe or unsafe based on a statistical comparison to the pickle file function call trace profile 170. When data associated with the pickle file function call trace 50 conforms to the pickle file function call trace profile 170, the model assessment application 62 may thus instruct the server 24/54 to generate the cybersecurity prediction 152 as an output, and the cybersecurity prediction 152 may have a value, rank, or category that represents the safe/normal operation 40. Because the pickle file function call trace 50 may be statistically described as the safe/normal operation 40, the model assessment application 62 may instruct the server 24 to label, rank, prioritize, or classify the pickle file function call trace 50 as benign, low priority, and/or not requiring further investigation. Urgent resources may thus be reallocated to other, higher-priority cybersecurity efforts.

Abnormal computer behavior may be flagged for review. When the server 24/54 determines or predicts that the pickle file function call trace 50 matches or resembles abnormal operation 46, urgent resources may be required. The pickle file function call trace 50, in other words, may represent an outlier or abnormal, anomalous, or perhaps even harmful hardware/software machine activities. The model assessment application 62 may thus instruct the server 24/54 to assign a high value, rank, urgency, or other category to the pickle file function call trace 50. The model assessment application 62 may instruct the server 24/54 to implement notification/quarantine/isolation/halt or other urgent threat procedures. The model assessment application 62 may also hand-off and/or queue the pickle file function call trace 50, the pickle file 34, and/or the AI/ML model 32 for a human analyst review by cybersecurity subject matter experts. Because the pickle file function call trace 50 has been screened and preliminarily assessed as the abnormal operation 46, the model assessment application 62 may route the pickle file function call trace 50, the pickle file 34, and/or the AI/ML model 32 to a human expert or group of human experts for an urgent, deep-dive analysis.

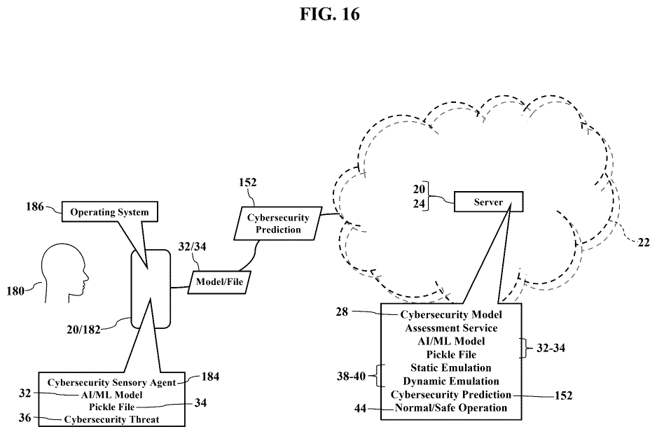

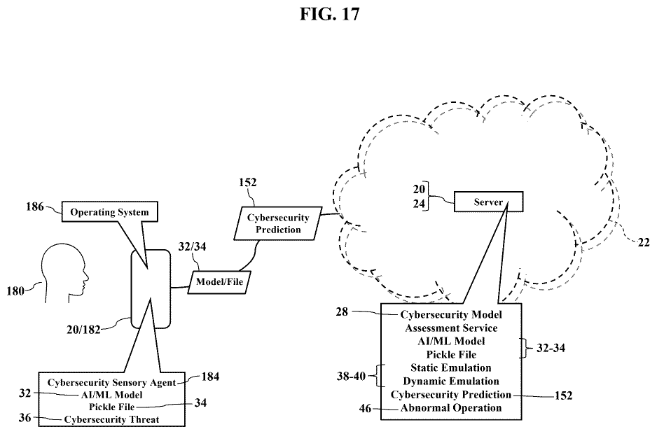

FIGS. 16-17 illustrate more examples of the cybersecurity model assessment service 28. Let's assume a human user 180 registers a mobile smartphone 182 for the model assessment service 28. The user 180, in other words, enrolls the smartphone 182 as a subscriber to the model assessment service 28. The user 180 wishes to read, listen to, and/or watch an email, webpage, text message, movie/image, music, or other electronic content. As the smartphone 182 processes the electronic content, though, the smartphone 182 is programmed to detect the pickle file 34 and/or the AI/ML model 32 embedded within, downloadable by, linked to, or otherwise associated with the electronic content. Because the model assessment service 28 protects the user's smartphone 182 from potential cybersecurity threats 36, the model assessment service 28 also monitors the user's smartphone 182 for malicious pickle files 34 and/or malicious AI/ML models 32.

The smartphone 182 may alert the cloud computing environment 22. Because the smartphone 182 subscribes to the model assessment service 28, the smartphone 182 may download, store, and execute an endpoint cybersecurity sensory agent 184. The cybersecurity sensory agent 184 includes computer programs, code, or instructions that scan and monitor its corresponding host (e.g., the smartphone 182) for events, communications, processes, activities, behaviors, data values, contexts, and/or patterns that indicate evidence of the pickle file 34 and AI/ML model 32. The cybersecurity sensory agent 184, for example, interfaces with an operating system 186 (perhaps as an antimalware driver) to establish OS event notifications of hardware and software events related to the file/model 34/32. Should the event notifications indicate that the file/model 34/32 is being called/downloaded/requested/stored/processed, the cybersecurity sensory agent 184 instructs the smartphone 182 to generate a request for the cybersecurity model assessment service 28.

The cybersecurity model assessment service 28 evaluates the pickle file 34 and/or AI/ML model 32. The cybersecurity sensory agent 184, for example, may instruct the smartphone 182 to at least partially download and store the file/model 34/32. However, the cybersecurity sensory agent 184 may forbid or limit processing/execution of the file/model 34/32 prior to the cybersecurity model assessment service 28. That is, prior to running/executing/using the file/model 34/32, the endpoint cybersecurity sensory agent 184 may instruct the smartphone 182 to perform only limited preprocessing or reading of the file/model 34/32. The cybersecurity sensory agent 184, as an example, may cooperate with the operating system 186 to send the file/model 34/32 to the network address (e.g., IP address) associated with the cloud computing environment 22 and/or the cybersecurity model assessment service 28. The cybersecurity sensory agent 184, however, may cooperate with the operating system 186 to sample the pickle file 34 and to obtain one or more of the function calls 52 associated with the pickle file 34. The cybersecurity sensory agent 184 may then cooperate with the operating system 186 to send the pickle file 34 and/or the function call(s) 52 to the network address (e.g., IP address) associated with the cloud computing environment 22 and/or the cybersecurity model assessment service 28. The cybersecurity sensory agent 184 may then instruct the operating system 186 to await further instructions or authorization.

The server 24 is programmed to provide at least a portion of the cybersecurity model assessment service 28. When the cloud computing environment 22 receives the request for the cybersecurity model assessment service 28, the networked members 26 (illustrated in FIG. 1) of the cloud computing environment 22 may then route, forward, or send the byte content representing the pickle file 34 and/or the function call(s) 52 to the server 24 for analysis. The server 24, for example, determines the pickle file function call trace 50 by conducting the static emulation 38 and/or the dynamic emulation 40. The server 24 may further generate the cybersecurity prediction 152 using the pickle file function call trace 50. The cybersecurity prediction 152, for example, may predict that the pickle file function call trace 50 represents safe/normal operation 40. The server 24 may send the cybersecurity prediction 152 to the network address (e.g., IP address) associated with the smartphone 182. When the smartphone 182 receives the cybersecurity prediction 152, the operating system 182 may send/forward/pass the cybersecurity prediction 152 to the endpoint cybersecurity sensory agent 184. The cybersecurity sensory agent 184 inspects the cybersecurity prediction 152 and determines that the cybersecurity prediction 152 authorizes, permits, and/or instructs the cybersecurity sensory agent 184 to permit further downloading, storing, executing, and/or otherwise resuming processing of the pickle file 34 and/or the AI/ML model 32. That is, because the file/model 34/32 is predicted to cause safe computer activity/behavior/context, the file/model 34/32 is predicted as safe to run.

As FIG. 17 illustrates, though, the server 24 may deny execution. When the server 24 analyzes the byte content representing the pickle file function call trace 50, the server 24 may predict the abnormal operation 46. If, for example, the pickle file function call trace 50 is predicted to be abnormal operation 46, the server 24 may restrict processing. The server 24 may thus generate and send the cybersecurity prediction 152 to the smartphone 182, and the cybersecurity prediction 152 denies authorization or permission to further download, store, execute, and/or otherwise resume processing of the file/model 34/32. Simply put, the file/model 34/32 is predicted as unsafe to run.

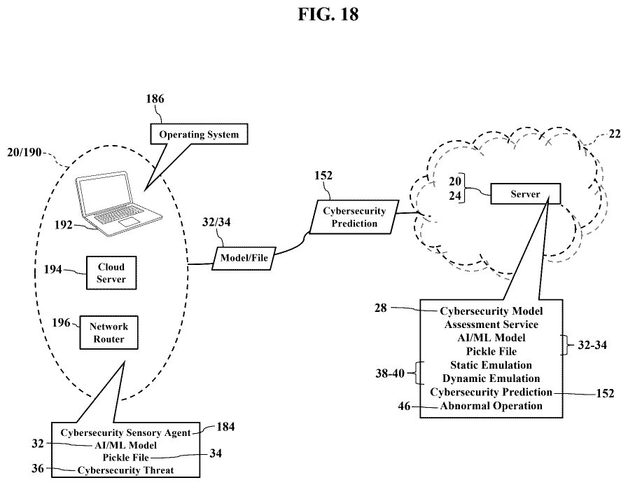

FIG. 18 illustrates still more examples of the cybersecurity model assessment service 28. The cybersecurity model assessment service 28 may protect other client devices 190 from potential cybersecurity threats 36. FIG. 18, for example, illustrates a laptop computer 192, a cloud server 194, and a network router 196 as subscribers to the cybersecurity model assessment service 28. Whatever the client device 190, each client device 190 downloads/installs the endpoint cybersecurity sensory agent 184. The cybersecurity sensory agent 184 interfaces with the operating system 186 to establish OS event notifications of hardware and software events related to the file/model 34/32. Should the event notifications indicate that the file/model 34/32 is being called/downloaded/requested/stored/processed, the cybersecurity sensory agent 184 instructs the host client device 190 to generate the request for the cybersecurity model assessment service 28. The cybersecurity sensory agent 184 may then instruct the operating system 186 to await further instructions or authorization. The server 24 generates the function call trace 50 by conducting the static/dynamic emulations 38/40. The server 24 may further generate the cybersecurity prediction 152 using the function call trace 50. The server 24 may send the cybersecurity prediction 152 to the network address (e.g., IP address) associated with the smartphone 182. The cybersecurity sensory agent 184 inspects the cybersecurity prediction 152 and determines whether the cybersecurity prediction 152 authorizes or denies the pickle file 34 and/or the AI/ML model 32.

The cybersecurity model assessment service 28 may thus scan pickle files 34 and/or AI/ML models 32. The cybersecurity model assessment service 28, for example, may scan pickle files 34 and/or AI/ML models 32 discovered inside Docker images that are stored inside a registry of a customer. The cybersecurity model assessment service 28, as more examples, may ping or contact public and/or private IP addresses for the presence of pickle files 34 and/or AI/ML models 32. Any pickle files 34 and/or AI/ML models 32 found may be scanned and assessed for malicious content. The cybersecurity model assessment service 28, as more examples, may integrate with the cybersecurity sensory agent 184 that alerts/notifies/signals at runtime when it detects the pickle file 34 and/or AI/ML model 32. The cybersecurity sensory agent 184 may send the pickle file 34 and/or AI/ML model 32 to the cloud-based cybersecurity model assessment service 28. The cybersecurity sensory agent 184, however, may alternatively locally assess the pickle file 34 and/or AI/ML model 32. The cybersecurity sensory agent 184 may generate the pickle file function call trace 50 by locally conducting the static/dynamic emulations 38/40. The cybersecurity sensory agent 184 may further generate the cybersecurity prediction 152 using the pickle file function call trace 50.

The cybersecurity sensory agent 184 may thus have permissions. The cybersecurity sensory agent 184 is installed on the host computer system 20 (e.g., the client device 182/190) and is stored in a host memory device (not shown for simplicity). The cybersecurity sensory agent 184 is executed by a host hardware processor (not shown for simplicity). The cybersecurity sensory agent 184, for example, may have kernel-level components having kernel-level permissions to a kernel of the host operating system 186. The cybersecurity sensory agent 184 may additionally have user-mode components having user-level permissions to a user mode of the operating system 186. The cybersecurity sensory agent 184 may include computer program, code, or instructions that register with the operating system 186 as the antimalware driver. The cybersecurity sensory agent 184 may thus register with, or subscribe to, the operating system 186 for event notifications. The cybersecurity sensory agent 184, for example, specifies operating system and/or software events associated with the pickle file 34 and/or the AI/ML model 32. The operating system 186 then notifies the cybersecurity sensory agent 184, via the event notification, when the operating system 186 detects the pickle file 34 and/or the AI/ML model 32. Moreover, because the cybersecurity sensory agent 184 is authorized as the antimalware driver, the operating system 186 may await instructions or commands from the cybersecurity sensory agent 184. So, when the operating system 186 notifies the cybersecurity sensory agent 184 of the pickle file 34 and/or the AI/ML model 32, the operating system 186 may defer or wait further instructions from the cybersecurity sensory agent 184. The cybersecurity sensory agent 184 may also instruct operating system 186 to report the pickle file 34 and/or the AI/ML model 32 to the cloud computing environment 22 (illustrated in FIG. 1) and to the cloud-based cybersecurity model assessment service 28.

The cybersecurity sensory agent 184 specifies the pickle file 34 and/or the AI/ML model 32. The cybersecurity sensory agent 184 may instruct the operating system 186 to notify of operating system events, software events, communications, processes, activities, behaviors, data values, usernames/logins, locations, contexts, and/or patterns that indicate the pickle file 34 and/or the AI/ML model 32. The cybersecurity sensory agent 184 may be notified of kernel-level activity and/or user-mode activity conducted by the operating system 186 and/or by other software applications. The cybersecurity sensory agent 184 may register for and receive kernel-level notifications, user-level notifications, and call backs from the operating system 186. The cybersecurity sensory agent 184 may thus interface with the operating system 186 and/or with other software applications to receive any data (such as runtime values, messages, input/output requests, system calls, reads/writes, launches, files, and memory allocations).

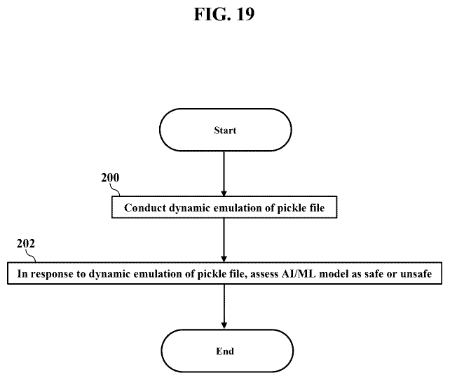

FIG. 19 illustrates examples of a method or operations that assess the AI/ML model 32. The computer system 20 conducts the dynamic emulation 40 of the pickle file 34 (Block 200). Then, in response to the dynamic emulation 40 of the pickle file 34, the computer system 20 assesses the AI/ML model 32 as safe or unsafe (Block 202).

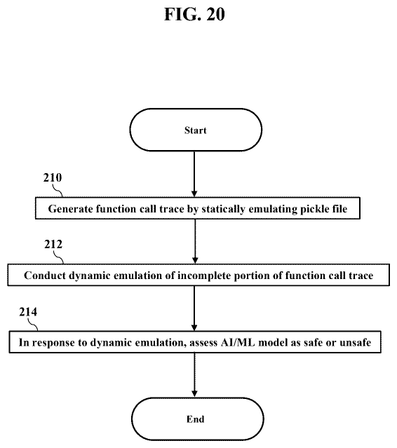

FIG. 20 illustrates examples of more methods or operations that assess the AI/ML model 32. The computer system 20 generates the pickle file function call trace 50 by statically emulating the pickle file 34 associated with the AI/ML model 32 (Block 210). The computer system 20 conducts the dynamic emulation 40 of an incomplete portion of the pickle file function call trace 50 (Block 212). Then, in response to the dynamic emulation 40 of the incomplete portion of the function call trace 50, the computer system 20 assesses the AI/ML model 32 as safe or unsafe (Block 214).

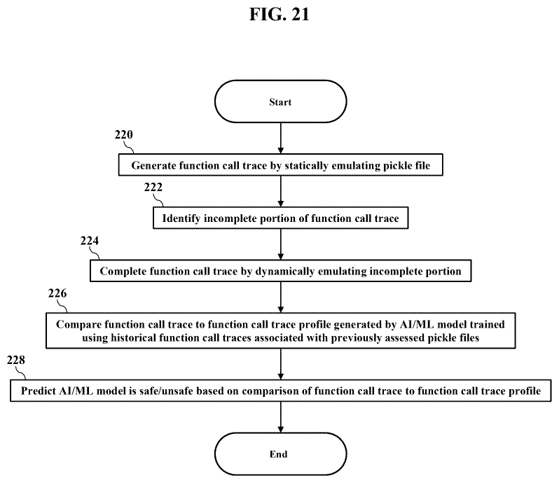

FIG. 21 illustrates examples of still more methods or operations that assess the AI/ML model 32. The computer system 20 generates the pickle file function call trace 50 by statically emulating the pickle file 34 associated with the AI/ML model 32 (Block 220). The computer system 20 identifies an incomplete portion of the pickle file function call trace 50 (Block 222). The computer system 20 completes the pickle file function call trace 50 associated with the pickle file 34 by dynamically emulating the incomplete portion (Block 224). The computer system 20 compares the pickle file function call trace 50 associated with the pickle file 34 to the pickle file function call trace profile 170 generated by the machine learning model 172 trained using the historical pickle file function call traces 150 associated with previously assessed pickle files (Block 226). The computer system 20 predicts the AI/ML model 32 is safe or unsafe based on the comparing of the pickle file function call trace 50 to the pickle file function call trace profile 170 generated by the machine learning model 172 trained using the historical pickle file function call traces 150 associated with previously assessed pickle files (Block 228).

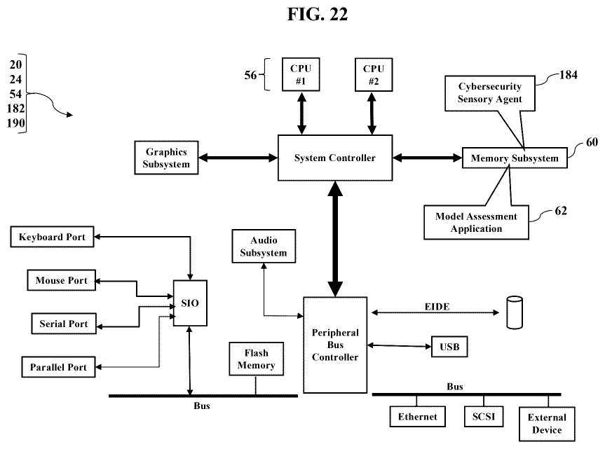

FIG. 22 illustrates more detailed examples of the operating environment. FIG. 22 is a more detailed block diagram illustrating the computer system 20 and the client device 190. The model assessment application 62 and/or the endpoint cybersecurity sensory agent 184 is stored in the memory subsystem or device 60. One or more of the hardware processors 56 communicate with the memory subsystem or device 60 and execute the model assessment application 62 and/or the endpoint cybersecurity sensory agent 184. Examples of the memory subsystem or device 60 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and other read/write memory technology. Because the computer system 20 and the client device 190 is/are known to those of ordinary skill in the art, no detailed explanation is needed.

The computer system 20 and the client device 190 may have other embodiments. This disclosure mostly discusses the computer system 20 as the server 24 and the client device 190 as the smartphone 182. The model assessment service 28, however, may be easily adapted to other stationary or mobile computing examples, such as a desktop computer, a tablet computer, a smartwatch, and a network switch. The model assessment service 28 may also be easily adapted to other embodiments of smart devices, such as a television, an audio device, a remote control, and a recorder. The model assessment service 28 may also be easily adapted to still more smart appliances, such as washers, dryers, and refrigerators. Indeed, as cars, trucks, and other vehicles grow in electronic usage and in processing power, the model assessment service 28 may be easily incorporated into a vehicular controller.

The above examples of the model assessment service 28 may be applied regardless of the networking environment. The model assessment service 28 may be easily adapted to stationary or mobile devices having wide-area networking (e.g., 4G/LTE/5G/6G/7G cellular), wireless local area networking (WI-FI®), near field, and/or BLUETOOTH® capability. The model assessment service 28 may be applied to stationary or mobile devices utilizing any portion of the electromagnetic spectrum and a signaling standard (such as the IEEE 802 family of standards, GSM/CDMA/TDMA or other cellular standard, and/or the ISM band). The model assessment service 28, however, may be applied to a processor-controlled device operating in the radio-frequency domain and/or the Internet Protocol (IP) domain. The model assessment service 28 may be applied to a processor-controlled device utilizing a distributed computing network, such as the Internet (sometimes alternatively known as the “World Wide Web”), an intranet, a local-area network (LAN), and/or a wide-area network (WAN). The model assessment service 28 may be applied to a processor-controlled device utilizing power line technologies, in which signals are communicated via electrical wiring. Indeed, the many examples may be applied regardless of physical componentry, physical configuration, or communications standard(s).

The model assessment service 28 may utilize a processing component, configuration, or system. For example, the model assessment service 28 may be easily adapted to a desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, or other manufacturer. The model assessment service 28 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The model assessment service 28 may use packetized communications. When the computer system 20 communicates via communications networks, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The model assessment service 28 may utilize a signaling standard. The computer system 20 and/or the cloud computing environment 22 may mostly use wired networks to interconnect network members. However, the computer system 20 and/or the cloud computing environment 22 may utilize other communications devices using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or a variant of the GSM/CDMA/TDMA signaling standard. The model assessment service 28 may also utilize other standards, such as the I.E.E.E. 802 family of standards, the Industrial, Scientific, and Medical band of the electromagnetic spectrum, BLUETOOTH®, low-power or near-field, and other standard or value.

The model assessment service 28 may be physically embodied on or in a computer-readable storage medium. This computer-readable medium, for example, may include CD-ROM, DVD, tape, cassette, floppy disk, optical disk, USB flash memory drive, memory card, memory drive, and large-capacity disks. This computer-readable medium, or media, could be distributed to end-subscribers, licensees, and assignees. A computer program product comprises processor-executable instructions for assessing pickle files 34 associated with AI/ML models 32, as the above paragraphs explain.

The diagrams, schematics, illustrations, and the like represent conceptual views or processes illustrating examples of assessing pickle files 34 associated with AI/ML models 32. The functions of the various elements shown in the figures may be provided through the use of dedicated hardware as well as hardware capable of executing instructions. The hardware, processes, methods, and/or operating systems described herein are for illustrative purposes and, thus, are not intended to be limited to a particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system that assesses an artificial intelligence (AI) model, comprising:
conducting, by the computer system, a dynamic emulation of a pickle file associated with the AI model; and
determining, by the computer system, a cybersecurity threat associated with the AI model based on the dynamic emulation of the pickle file.

2. The method of claim 1, further comprising categorizing the pickle file as a normal computer behavior.

3. The method of claim 1, further comprising categorizing the pickle file as an abnormal computer behavior.

4. The method of claim 1, further comprising conducting a static emulation of the pickle file associated with the AI model.

5. The method of claim 1, further comprising generating a cybersecurity prediction based on the dynamic emulation of the pickle file associated with the AI model.

6. The method of claim 1, further comprising comparing a function call associated with the pickle file to function calls associated with known AI models previously assessed.

7. The method of claim 6, further comprising categorizing the pickle file as safe or unsafe based on the comparing of the function call to the function calls associated with the known AI models previously assessed.

8. A computer system that assesses an artificial intelligence (AI) model, comprising:
at least one central processing unit; and
at least one memory device storing instructions that, when executed by the at least one central processing unit, perform operations, the operations comprising:
generating a function call trace by statically emulating a pickle file associated with the AI model;
conducting a dynamic emulation of an incomplete portion of the function call trace generated by the statically emulating of the pickle file; and
determining a cybersecurity threat associated with the AI model based on the dynamic emulation of the incomplete portion of the function call trace.

9. The computer system of claim 8, wherein the operations further comprise categorizing the pickle file as a normal computer behavior.

10. The computer system of claim 8, wherein the operations further comprise categorizing the pickle file as an abnormal computer behavior.

11. The computer system of claim 8, wherein the operations further comprise generating a cybersecurity prediction based on the dynamic emulation of the incomplete portion of the function call trace.

12. The computer system of claim 8, wherein the operations further comprise comparing the function call trace associated with the pickle file to historical function call traces associated with AI models previously assessed.

13. The computer system of claim 12, wherein the operations further comprise categorizing the pickle file as safe or unsafe based on the comparing of the function call trace to the historical function call traces associated with the AI models previously assessed.

14. A memory device storing instructions that, when executed by at least one central processing unit, perform operations, comprising:
generating a pickle file function call trace by statically emulating a pickle file associated with an artificial intelligence (AI) model;
identifying an incomplete portion of the pickle file function call trace generated by the statically emulating of the pickle file;
completing the pickle file function call trace associated with the pickle file by dynamically emulating the incomplete portion of the pickle file function call trace;
comparing the pickle file function call trace associated with the pickle file to a pickle file function call trace profile generated by a machine learning model trained using historical pickle file function call traces associated with pickle files previously assessed; and
predicting the AI model is safe or unsafe based on the comparing of the pickle file function call trace associated with the pickle file to the pickle file function call trace profile generated by the machine learning model trained using the historical pickle file function call traces associated with the pickle files previously assessed.

15. The memory device of claim 14, wherein the operations further comprise generating a cybersecurity prediction based on the comparing of the pickle file function call trace associated with the pickle file to the pickle file function call trace profile generated by the machine learning model.

16. The memory device of claim 14, wherein the operations further comprise associating the pickle file with a normal operation in response to determining that the pickle file function call trace conforms to the pickle file function call trace profile generated by the machine learning model.

17. The memory device of claim 14, wherein the operations further comprise associating the pickle file with an abnormal operation in response to determining that the pickle file function call trace fails to conform to the pickle file function call trace profile generated by the machine learning model.

18. The memory device of claim 14, wherein the operations further comprise categorizing the pickle file as a normal operation.

19. The memory device of claim 14, wherein the operations further comprise categorizing the pickle file as an abnormal operation.

20. The memory device of claim 14, wherein the operations further comprise categorizing the pickle file as the safe or the unsafe based on the comparing of the pickle file function call trace to the pickle file function call trace profile generated by the machine learning model.
